(19) United States
(12) Patent Application Publication
(10) Pub. No.: US 2021/0190421 A1
(43) Pub. Date: Jun. 24, 2021

(54) METHOD AND APPARATUS FOR SUPPLYING A CRYOGENIC STREAM WITH A CONTROLLED TEMPERATURE FROM A BACK-UP SYSTEM

(71) Applicant: L'Air Liquide, Societe Anonyme pour l'Etude et l'Exploitation des Procedes Georges Claude, Paris (FR)

(72) Inventors: Patrick LE BOT, Vincennes (FR); Pierre-Philippe GUERIF, Houston, TX (US); Vincent FOLLACA, Houston, TX (US)

(73) Assignee: L'Air Liquide, Societe Anonyme pour l'Etude et l'Exploitation des Procedes Georges Claude, Paris (FR)

(21) Appl. No.: 16/724,191

(22) Filed: Dec. 21, 2019

(51) Int. Cl. F25J 3/04

(52) U.S. Cl. CPC F25J 3/04478; F25J 3/04636; F25J 3/04254; F25J 2290/60; F25J 2205/40; F25J 2280/02; F25J 2205/90

(57) ABSTRACT

A method for temperature-controlled delivery of the gaseous product at temperatures at or below ambient in the event of an air separation unit failure. In one embodiment, a first portion of a stored cryogenic liquid product is sent to the back-up vaporizer and heated to ambient conditions, and a second portion of stored cryogenic liquid product, which is at the cryogenic storage temperature, bypasses the back-up vaporizer using a bypass line controlled by a bypass valve and is mixed with the vaporized gas. This mixed stream will then preferably go through a static mixer in order to get to an homogenous temperature that is below the ambient temperature. A temperature control loop can be used to adjust the opening of the by-pass valve in order to reach the desired product temperature.

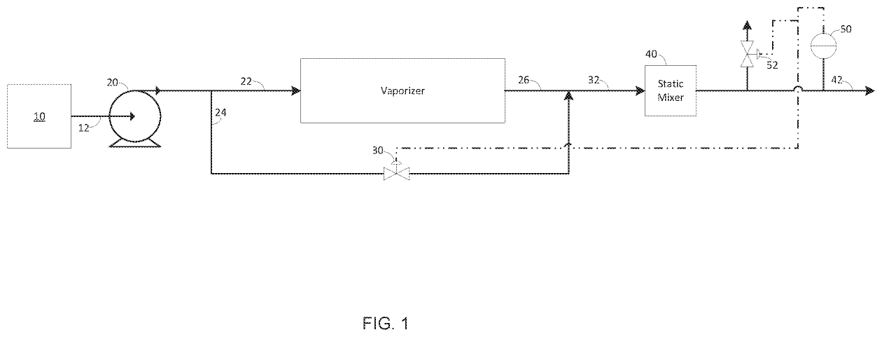

### TECHNICAL FIELD

The present invention generally relates to a method for producing a gaseous product from a cryogenic liquid storage device. The method and apparatus are particularly useful for producing gaseous oxygen and/or nitrogen in the event of an air separation unit (ASU) failure.

### BACKGROUND OF THE INVENTION

Oxygen and nitrogen products are typically supplied by an ASU. In order to increase the reliability of an ASU, a back-up system, which is typically located nearby the ASU, can include one or several liquid storages, one or several vaporizers and sometimes one or several pumps. In the event of the ASU going down, the back-up vaporizer kicks in to supply oxygen or nitrogen, typically at ambient temperature, by vaporizing the cryogenic liquid.

For some particular applications, oxygen and/or nitrogen are needed at temperatures colder than ambient. For example, at 0° C., or even less such as −20° C. to −50° C. As such, there is a need to supply gaseous products at temperatures below ambient from the same back-up vaporization system.

### BRIEF SUMMARY OF THE INVENTION

The present invention is directed to a device and a method that satisfies at least one of these needs. Certain embodiments of the current invention allow for temperature-controlled delivery of the gaseous product at temperatures at or below ambient temperatures.

In one embodiment, a first portion of the liquid product is sent to the back-up vaporizer and heated to ambient conditions, and a second portion of the liquid product, which is at the storage temperature, bypasses the back-up vaporizer using a bypass line controlled by a bypass valve and is mixed with the product gas. This mixed stream will then preferably go through a static mixer in order to get to an homogenous temperature. In a preferred embodiment, a temperature control loop can be used to adjust the opening of the by-pass valve (in order to control the mass flow rate of the liquid cryogen) in order to reach the desired product temperature.

In a preferred embodiment, the temperature indicator is proximal the end gas user, such that any temperature losses between the static mixer and the end user are taken into account. In another embodiment, the mixture can be vented until the temperature of the mixture is within the desired temperature range. Other typical control processes known to those skilled in the art can also be used (e.g., feed forward, delay during start-up sequencing).

In one embodiment, a method for controlling the temperature of a vaporized fluid coming from a back-up vaporization system after detection of a disturbance in production of an air separation unit (ASU) is provided. In one embodiment, the method comprises: providing a cryogenic fluid from a liquid storage tank; splitting the cryogenic fluid into a first stream and a second stream; vaporizing the first stream in a vaporizer to produce a first gaseous stream at a first temperature that is about ambient temperature; and mixing the first gaseous stream with the second stream, which is at a second temperature that is lower than the first temperature, to create a mixed stream that is at a mixed temperature which is greater than the second temperature and lower than the first temperature, wherein the second stream bypasses the vaporizer before mixing with the first gaseous stream. In a preferred embodiment, the flow rate of the second stream is controlled to bring the mixed temperature within a desired product temperature range. Additionally, the cryogenic fluid can be selected from the group consisting of oxygen, nitrogen, argon, xenon, and krypton.

In optional embodiments of the method for controlling the temperature of the vaporized fluid:
the first temperature and the second temperature differ by at least 100° C.;
the flow rate of the second stream can be controlled by a by-pass control valve that is in communication with a temperature controller that is configured to determine the mixed temperature; and/or
the method can further include the step of venting the mixed stream if the mixed temperature is outside of the desired product temperature range.

In another embodiment, an apparatus for controlling the temperature of a vaporized fluid coming from a back-up vaporization system after detection of a disturbance in production of an air separation unit (ASU) is provided. In this embodiment, the apparatus can include: a cryogenic liquid storage tank configured to store a cryogenic liquid at a temperature below −50° C.; splitting the cryogenic fluid into a first stream and a second stream; a vaporizer in fluid communication with the cryogenic liquid storage tank, wherein the vaporizer is configured to vaporize cryogenic liquid received from the cryogenic liquid storage tank to produce a gaseous fluid at an ambient temperature; a bypass line having a bypass valve, wherein the bypass line is configured to receive a portion of the cryogenic liquid upstream of the vaporizer and then introduce the portion of the cryogenic liquid to a mixer thereby producing a mixed stream at a mixed temperature, wherein the mixer is configured to mix the portion of the cryogenic liquid and the gaseous fluid at a location downstream the vaporizer; and a controller configured to adjust the mixed temperature to be within a desired product temperature range.

In optional embodiments of the apparatus for controlling the temperature of the vaporized fluid:
the controller adjusts the mixed temperature by adjusting the flow rate of the portion of the cryogenic liquid through the bypass valve;
the apparatus can also include a vent valve disposed downstream the mixer;

and/or
the vent valve is configured to open if the mixed temperature is outside of the desired product temperature range and close once the mixed temperature is within the desired product temperature range.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features, which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawings, in which:

The FIGURE is a process flow diagram of an embodiment of the present invention.

### DETAILED DESCRIPTION OF THE INVENTION

Referring to the FIGURE, cryogenic fluid 12 is withdrawn from cryogenic storage 10 using pump 20. Preferable cryogenic fluids include air gases that can be sourced from an ASU, such as nitrogen, oxygen, argon, krypton, and xenon.

Cryogenic fluid 12 is then split into first stream 22 and second stream 24, wherein first stream 22 is sent to the vaporizer, thereby producing vaporized fluid 26, which is preferably at ambient temperature. Vaporizer can be any type of fluid vaporizer known in the art, such as atmospheric or water-bath type vaporizers.

Bypass valve 30 is open to an appropriate amount, thereby inducing a flow of second stream 24 to bypass the vaporizer, wherein the second stream 24 is mixed with vaporized fluid 26 to produce mixed fluid 32 having a mixed temperature. In the embodiment shown, mixed fluid 32 is preferably sent to static mixer 40 to ensure a more homogenous stream. Product gaseous stream 42 is withdrawn from static mixer 40 and sent to downstream customer (not shown).

As part of the control process, temperature indicator 50 is used to measure the mixed temperature, and based on the measured mixed temperature; the flow rate of stream 24 is adjusted in order to be in the desired temperature range by adjusting the openness of bypass valve 30. In one embodiment, vent valve 52 can be used to vent the mixed fluid 42 in the event the mixed temperature is too far away from the desired temperature range. In a preferred embodiment, temperature indicator 50 is located as close as practicable to the end user, such that the end user receives the product gaseous stream 42 at the appropriate temperature.

In one embodiment, as close as practicable is meant to encompass a distance wherein the heat losses for the product gaseous stream 42 are minimal such that the temperature of the product gaseous stream 42 stays within the desired temperature range after the temperature indicator 50. In another embodiment, as close as practicable is meant to encompass a distance where the temperature losses after the temperature indicator 50 are determinable with reasonable certainty.

While the embodiments described with reference to the FIGURE specifically disclose oxygen and nitrogen as being the cryogenic fluid, those of ordinary skill in the art will recognize that other cryogenic fluids can also be included.

As used herein—cryogenic fluid is meant to encompass any fluid that is at a temperature of less than −50° C. As used herein—a temperature that is “close to” or “about” is the same as or within 5° C. of the referenced temperature.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

The present invention may suitably comprise, consist or consist essentially of the elements disclosed and may be practiced in the absence of an element not disclosed. Furthermore, if there is language referring to order, such as first and second, it should be understood in an exemplary sense and not in a limiting sense. For example, it can be recognized by those skilled in the art that certain steps can be combined into a single step or reversed in order.

The singular forms “a”, “an” and “the” include plural referents, unless the context clearly dictates otherwise.

“Comprising” in a claim is an open transitional term which means the subsequently identified claim elements are a nonexclusive listing (i.e., anything else may be additionally included and remain within the scope of “comprising”). “Comprising” as used herein may be replaced by the more limited transitional terms “consisting essentially of” and “consisting of” unless otherwise indicated herein.

“Providing” in a claim is defined to mean furnishing, supplying, making available, or preparing something. The step may be performed by any actor in the absence of express language in the claim to the contrary a range is expressed, it is to be understood that another embodiment is from the one.

Optional or optionally means that the subsequently described event or circumstances may or may not occur. The description includes instances where the event or circumstance occurs and instances where it does not occur.

Ranges may be expressed herein as from about one particular value, and/or to about another particular value. When such particular value and/or to the other particular value, along with all combinations within said range.

All references identified herein are each hereby incorporated by reference into this application in their entireties, as well as for the specific information for which each is cited.

What is claimed is:

1. A method for controlling the temperature of a vaporized fluid coming from a back-up vaporization system after detection of a disturbance in production of an air separation unit (ASU), the method comprising the steps of:
providing a cryogenic fluid from a liquid storage tank;
splitting the cryogenic fluid into a first stream and a second stream;
vaporizing the first stream in a vaporizer to produce a first gaseous stream at a first temperature that is about ambient temperature; and
mixing the first gaseous stream with the second stream, which is at a second temperature that is lower than the first temperature, to create a mixed stream that is at a mixed temperature which is greater than the second temperature and lower than the first temperature, wherein the second stream bypasses the vaporizer before mixing with the first gaseous stream,
wherein the flow rate of the second stream is controlled to bring the mixed temperature within a desired product temperature range,
wherein the cryogenic fluid is selected from the group consisting of oxygen, nitrogen, argon, xenon, and krypton.

2. The method of claim 1, wherein the first temperature and the second temperature differ by at least 100° C.

3. The method of claim 1, wherein the flow rate of the second stream is controlled by a by-pass control valve that is in communication with a temperature controller that is configured to determine the mixed temperature.

4. The method of claim 1, further comprising the step of venting the mixed stream if the mixed temperature is outside of the desired product temperature range.

5. An apparatus for controlling the temperature of a vaporized fluid coming from a back-up vaporization system after detection of a disturbance in production of an air separation unit (ASU), the apparatus comprising:
a cryogenic liquid storage tank configured to store a cryogenic liquid at a temperature below −50° C.;
splitting the cryogenic fluid into a first stream and a second stream;
a vaporizer in fluid communication with the cryogenic liquid storage tank, wherein the vaporizer is configured to vaporize cryogenic liquid received from the cryogenic liquid storage tank to produce a gaseous fluid at an ambient temperature;
a bypass line having a bypass valve, wherein the bypass line is configured to receive a portion of the cryogenic liquid upstream of the vaporizer and then introduce the portion of the cryogenic liquid to a mixer thereby producing a mixed stream at a mixed temperature, wherein the mixer is configured to mix the portion of the cryogenic liquid and the gaseous fluid at a location downstream the vaporizer; and
a controller configured to adjust the mixed temperature to be within a desired product temperature range.

6. The apparatus of claim 5, wherein the controller adjusts the mixed temperature by adjusting the flow rate of the portion of the cryogenic liquid through the bypass valve.

7. The apparatus of claim 5, further comprising a vent valve disposed downstream the mixer.

8. The apparatus of claim 7, wherein the vent valve is configured to open if the mixed temperature is outside of the desired product temperature range and close once the mixed temperature is within the desired product temperature range.
